(19) United States
(12) Patent Application Publication
(10) Pub. No.: US 2006/0075236 A1
(43) Pub. Date: Apr. 6, 2006

(54) Method and apparatus for high assurance processing

(76) Inventors: James Allen Marek, Anamosa, IA (US); David Arthur Greve, Cedar Rapids, IA (US)

Correspondence Address: ROCKWELL COLLINS, INC.;INTELLECTUAL PROPERTY DEPARTMENT, 400 COLLINS ROAD NE, M/S 124-323, CEDAR RAPIDS, IA, 52498, US

(21) Appl. No.: 10/957,416

(22) Filed: Sep. 30, 2004

(51) Int. Cl. H04L 9/00

(52) U.S. Cl. 713/171

(57) ABSTRACT

A method and apparatus for providing high assurance processing are herein disclosed. According to this example method, high assurance processing is provided by selecting a first active partition. A processor access cycle is received from a processor. Data is retrieved from a device according to the processor access cycle. The retrieved data is validated according to a selected active partition. The validated data is provided the processor.

### BACKGROUND

In order to support multi-tasked processing, a computer system needs to provide some rudimentary means to distinguish between a plurality of processing threads it is executing. The basic mechanism that supports multi-tasking is the context switch. A context switch is based on the premise that a processor provides specific configurations for each of a plurality of execution contexts. For example, an execution context will typically provide some form of hardware support that identifies a currently operative context. For instance, the processor may provide a current-context register that is used to identify a currently operable context. For such a currently operable context, the processor may provide context-specific hardware support. For example, a processor could provide a distinct stack pointer register for each possible context as one form of multi-context support. As the value of the current-context register is changed, the processor will use a different stack pointer, which is selected according to the value stored in the current-context register.

Hardware support in a processor is only the basic rudimentary support needed to perform multi-tasking in a computer system. In order to properly support a multi-tasking structure, the resources used by a particular task, which is normally executed in a distinct context, must be protected from inadvertent corruption from other tasks executing in other contexts. As such, the processor is needs to be augmented by some form of memory protection. Generally, memory protection is provided by a device called a memory management unit. A memory management unit uses context information provided by the processor as a means for protecting memory used by one context from being altered or examined by another context. As the processor continues to execute in one particular context, the processor will present memory access cycles to the memory management unit. The memory management unit will distinguish, on a processor cycle by cycle basis, memory accesses originating from different processor contexts. In order to protect a memory used by one context from inadvertent or deliberate corruption by a second context, the memory management unit will examine each memory cycle presented by the processor and determine if the memory cycle is targeted to an address that is valid for a particular context. In a typical implementation, the memory management unit will include a memory access privileged table. The memory access privileged table is typically organized according to a particular context. As such, an access cycle presented by the processor will typically include control signals that depict a current operative context. These signals are collectively known as a context identifier. The context identifier received from the processor is used to select a subset of the memory access privilege table. The memory access privileged table is used to store an address range for each particular context. The address range received from the memory access privileged table is compared against the address for a particular memory access cycle received from the processor. When the address presented by the processor for a particular access cycle is within an address range received from the memory access privileged table for a particular context, the processor is allowed to access the memory according to the access cycle. Otherwise, the memory management unit forces the processor to tale an exception. In response to the exception, the processor undergoes a recovery sequence in hopes of achieving stable operation.

Segmenting memory in this manner provides for a modest level of inter-task protection when multiple tasks are concurrently executed by a single processing unit. Typically, the level of protection offered by a management unit is sufficient to support isolation between operating system processes and user application processes. For instance, a memory management unit is a suitable means for protecting privileged operating system resources from a user application that is also running in the computer system. The quality of inter-task protection provided by a memory management unit is generally limited to a very low level. This is because a memory management unit is itself managed by software. For example, the memory access privilege tables included in a memory management unit are often loaded and managed by memory management software elements included in an operating system. As such, the quality of inter-task protection offered by a memory management unit is limited to the quality of the software that is responsible for managing the memory access privilege table included in the memory management unit.

The type of inter-task protection provided by a memory management unit, however, typically falls short of that required to protect mission critical applications from each other and from other lower-quality software applications. For example, there are many instanced where software executed in a multi-tasking computer system is critical to the safety of human beings. A few examples include, but are not limited to aircraft avionics and medical diagnostic equipment. In these cases, it becomes important to provide a greater level of partitioning amongst concurrently executing processes.

Hardware partition enforcement has now provided a better means for enforcing protection mechanisms between processes executed by a single processor. Hardware partition enforcement is provided by a device known as a partition management unit. A partition management unit is a novel apparatus that itself includes multiple memory management units. In this case, greater inter-task protection can be provided by segregating processor resources using partitions established by a partition management unit. One key feature is that the partition management unit provides a plurality of memory management units, each of which is programmed with partition-specific memory access privilege tables. In this situation, when one task needs greater protection from other tasks, it can be executed in a partition. When a partition switch occurs, an entirely new memory protection scheme is adopted using a hardware selection rather than allowing a memory management software element reload protection parameters into a single memory access privilege table. This is typically accomplished by a partition interval timer. The partition interval timer causes the processor to execute a small partition switch instruction sequence. The partition switch instruction sequence can be fashioned in a trusted manner mush more easily than a memory management function ordinarily used to update the configuration of a memory management unit because the partition switch instruction sequence performs a much more limited set of functions than the aforementioned memory management function provided by an operating system.

The notion of enforcing partitions through hardware provides a significantly higher level of protection against inter-task memory corruption. However, not even hardware enforced partitioning is a sufficient means to provide for a secure processing environment. In segmented memory architectures and in partitioned resource architectures, there is still ample room for a rouge process to corrupt memory allocated to a different process. More importantly, sensitive (e.g. classified) data can be compromised whenever a rouge process gains access to memory. Even a simple partition switch instruction sequence is vulnerable in this event.

### SUMMARY

A method and apparatus for providing high assurance processing are herein disclosed. According to this example method, high assurance processing is provided by selecting a first active partition. A processor access cycle is received from a processor. Data is retrieved from a device according to the processor access cycle. The retrieved data is validated according to a selected active partition. The validated data is provided the processor.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram depicts one example method for providing high assurance processing.

FIG. 2 is a flow diagram that depicts one alternative method for validating data before it is provided to a processor.

FIG. 3 is a flow diagram depicts one alternative method for validating data that comprises an instruction.

FIG. 4 is a flow diagram depicts an alternative example method for processing a partition switch.

FIG. 5 is a flow diagram depicts one alternative illustrative method for validating an instruction sequence.

FIG. 6 is a flow diagram that depicts yet another alternative method for providing high assurance processing wherein data stored in an external device is secured from other partitions.

FIG. 7 is a block diagram that depicts one example embodiment of an assurance processor.

FIG. 8 is a block diagram depicts one alternative example embodiment of a validation unit capable of validating encrypted data.

FIG. 9 is a block diagram that depicts yet another alternative embodiment of a validation unit that is capable of validating an instruction.

FIG. 10 is a block diagram that depicts another alternative embodiment of a validation unit capable of validating an instruction sequence.

FIG. 11 is block diagram of one alternative example embodiment of a validation unit capable of encrypting data before it is stored in a memory.

FIG. 12 is a block diagram that depicts one example embodiment of a high assurance processing system.

### DETAILED DESCRIPTION

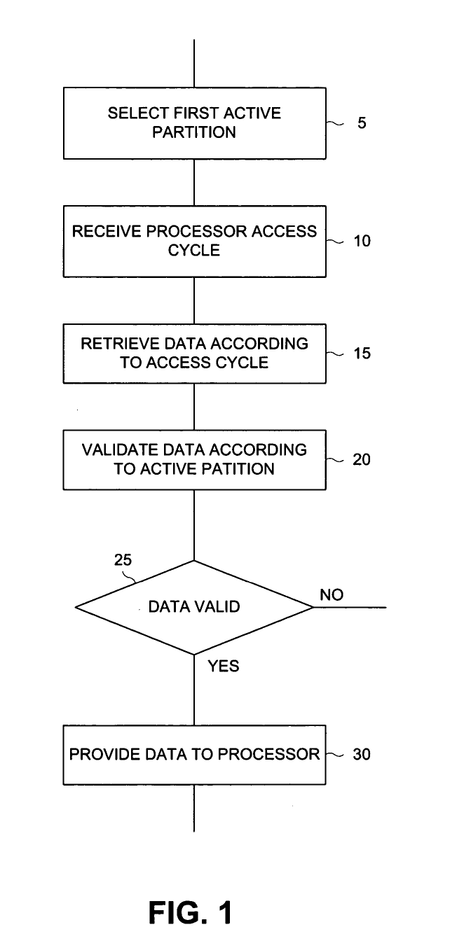

FIG. 1 is a flow diagram depicts one example method for providing high assurance processing. According to this example method, high assurance processing is provided by selecting a first active partition (step 5). Once the first active partition is selected, an access cycle is received from a processor (step 10). Based on the processor access cycle, data is retrieved from an external device (step 15). The external device, according to one variation of the present method, comprises a memory. In order to provide high assurance processing, the present example method provides for validating the retrieved data according to the active partition (step 20). For example, according to yet another variation of the present method, each partition supported under the present method provides for an associated validity mechanism. Once the data is validated (step 25), the data is provided to the processor (step 30). According to one illustrated use case, the present method may be applied collectively with a commercially available processor. As such, application of the present method and all of the teachings provided herein can be used to provide high assurance processing through the use of a commercially available off-the-shelf (COTS) processor.

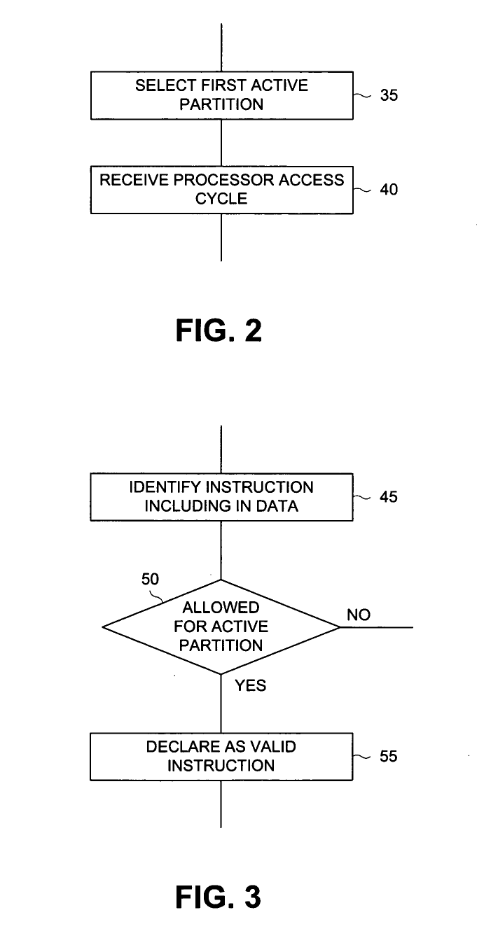

FIG. 2 is a flow diagram that depicts one alternative method for validating data before it is provided to a processor. The according to this example alternative method, data is validated by retrieving an encryption key for an active partition (step 35). For example, where a plurality of distinct partitions are supported, each particular partition will have its old encryption key. Data is retrieved from an external device and is decrypted (step 40) using the decryption key. The decrypted data is then provided to the processor as validated data. According to one illustrative use case, the present method is applied in a situation where a first process executing in a first partition needs to securely stored information in a memory. When a process executing in a different partition attempts to retrieve the data from the memory, a different (and invalid encryption key) will be used in an attempt to decrypt the data stored in the memory. Accordingly, only a process executing in the first partition will be able to probably decrypt and hence have access to the data stored in the memory.

FIG. 3 is a flow diagram depicts one alternative method for validating data that comprises an instruction. The present method, according to one alternative variation, provides for validating an instruction stored in an external device. Generally, a processor access cycle that is received from a processor will have associated with the cycle a type indicator. The cycle type indicator, according to one variation of the present method, is used to determine when a processor is accessing an instruction stored in an external device. As such, this variation of the present method provides for identifying an instruction included in the data retrieved from the external device (step 45). According to this variation of the present method, a particular partition will have associated therewith one or more allowable instructions. Such a list of allowable instruction, according to yet another variation of the present method, is structured to provide storage for a different allowable list of instructions for every partition contemplated by an embodiment of the present method. In response to an instruction fetch, data is retrieved from an external device and is compared against an enumeration of one or more allowable instructions for an active partition (step 50). When the data retrieved from the external device is found in the enumeration of allowable instructions for a particular partition, the data is declared valid (step 55) and provided to the processor. Once validated, the processor can continue executing the validated instruction in an ordinary matter. Typically, the processor will have privilege instructions which are used for special functions (e.g. input and output). Accordingly, a particular partition and may not be allowed to interact with an input or an output port. In such case, an input or output instruction will not be included in a list of allowable instructions for that partition.

It should be appreciated that a wide variety of different types of instructions can be included in an allowable instruction list for a particular partition and the claims appended hereto are not intended to be limited to input or output instructions. It should be further appreciated that according to yet another variation of present method, the allowable instruction list is replaced by a prohibited instruction list for a particular partition. In this situation, the present method will validate an instruction that is not included in the prohibited instruction list for particular partition. For the sake of the claims appended hereto, the use of a prohibited instruction list is to be considered equivalent to the use of an allowable instruction list when used to determine when an instruction is allowable for a particular partition. Accordingly, when a prohibited instruction list is used, and an instruction is validated when the instruction is not found in the list of prohibited instruction. Accordingly, this equivalence is intended to be applied in the reading of the claims appended hereto.

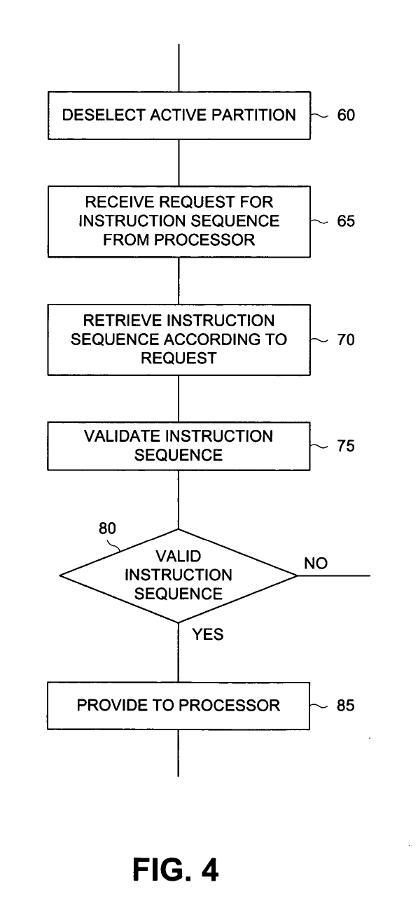

FIG. 4 is a flow diagram depicts an alternative example method for processing a partition switch. It should be appreciated that a partition switch is typically accomplished at a hardware level. Even still, a small instruction sequence is typically executed during a partition switch. In order to provide high assurance processing, the small instruction sequence, which is typically known as a partition switch instruction sequence, must be reliably executed. In order to be reliably executed, must be a high level of assurance that instruction sequence is correct and has not been modified surreptitiously. Accordingly, once an active partition is de-selected (step 60) according to this alternative variation of the present method, a request for an instruction sequence is received from a processor (step 65). An instruction sequence is then retrieved according to the request (step 70). Typically, the instruction sequence is retrieved from a memory device. The instruction sequence is then validated (step 75). When the instruction sequence is found to be valid (step 80), the instruction sequence is provided to the processor (step 85).

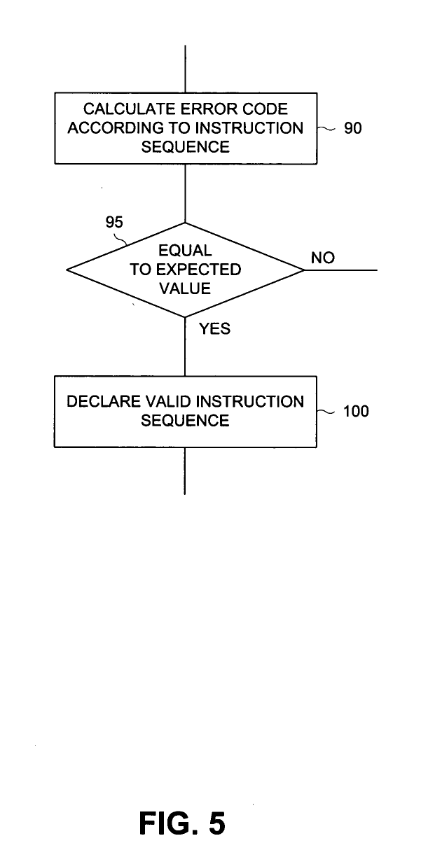

FIG. 5 is a flow diagram depicts one alternative illustrative method for validating an instruction sequence. According to this alternative method, validating an instruction sequence retrieved from memory is accomplished by calculating an error code according to the retrieved instruction sequence (step 90). When the calculated error code is found to be equal, or substantially equivalent to, an expected value (step 95), the instruction sequence is declared valid (step 100). According to yet another alternative variation of this method, an error code is calculated by generating a cyclic redundancy check code (typically known as a “CRC”) for the instruction sequence. According to yet another alternative variation of the present method, the error code for an instruction sequence of is generated by subjecting the instruction sequence to a hash function. The notion of a CRC code or a hash function can be applied commensurate with known teachings.

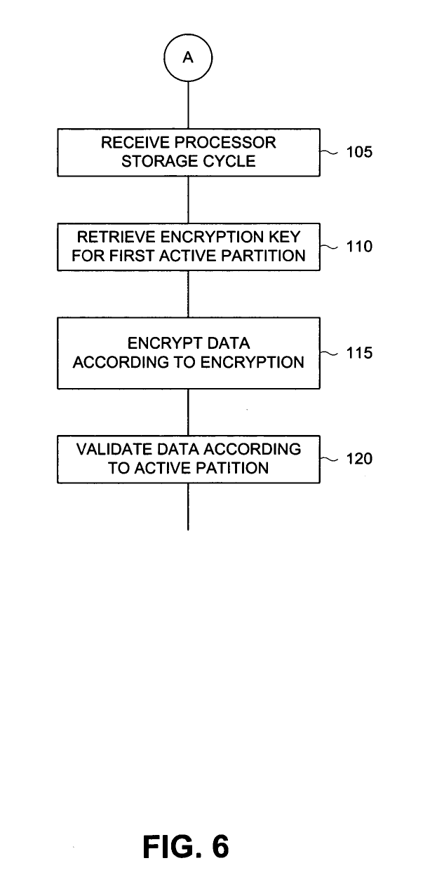

FIG. 6 is a flow diagram that depicts yet another alternative method for providing high assurance processing wherein data stored in an external device is secured from other partitions. According to this example alternative method, a processor storage cycle is received from a processor (step 105). An encryption key is retrieved for the first active partition (step 110). The data received from the processor by means of the processor storage cycle is then encrypted according to the retrieved encryption key (step 115) and directed to the device (step 120). According to one illustrative use case, when a process executing in one partition stores data in a memory, other processes executing in other partitions will not be able to decrypt the data unless another partition has associated therewith an identical encryption key.

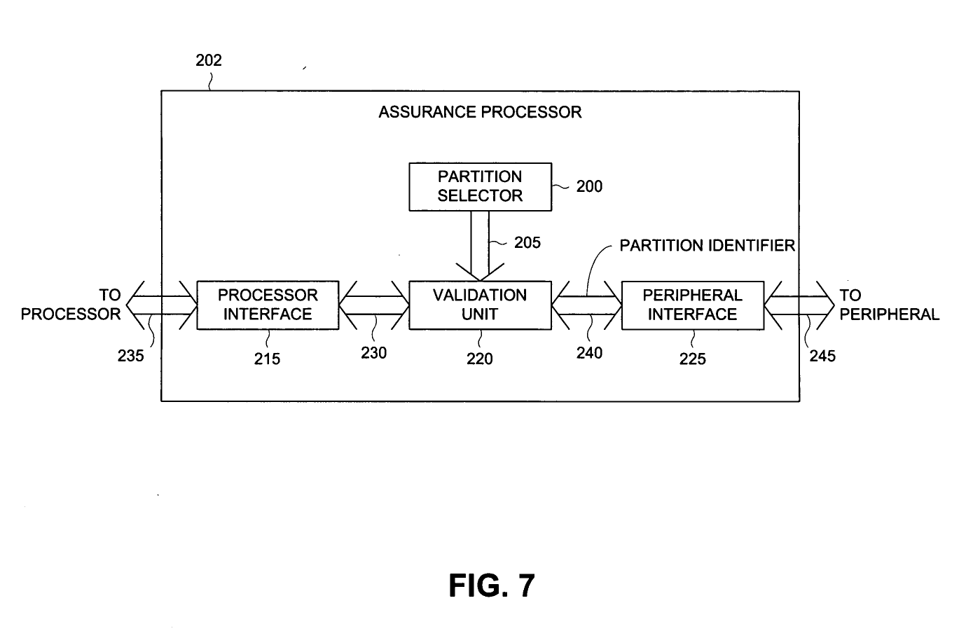

FIG. 7 is a block diagram that depicts one example embodiment of an assurance processor. According to this example embodiment, an assurance processor 202 comprises of partition selector 200. The partition selector 200 in this alternative embodiment provides a partition identifier, which is used as a means of identifying a currently active partition. The assurance processor 202 of this example embodiment further comprises a processor interface 215 and a peripheral interface 225. The processor interface 215 is capable of receiving a processor access cycle 235 from a processor. Disposed between the processor interface 215 and peripheral interface 225 is a validation unit 220. As such, the assurance processor 202 of this example embodiment further comprises said validation unit 220. The processor interface 215 directs a processor access cycle 230 to the validation unit 220. The validation unit 220 then propagates the processor access cycle to the peripheral interface 225. The peripheral interface 225 generates an access cycle 245 to peripheral device (e.g. a memory). Data is retrieved from a peripheral device according to an address included in a processor access cycle received by the processor interface 215. The data is retrieved from the peripheral and directed 240 to the validation unit 220. The validation unit 220 selects a validating criteria according to the partition identifier to fight it receives from the partition selector 200. What is validated the validation unit 220, is then provided to the processor interface 215. Processor interface 215 and provides the validated to the processor to the commercial processor and 35.

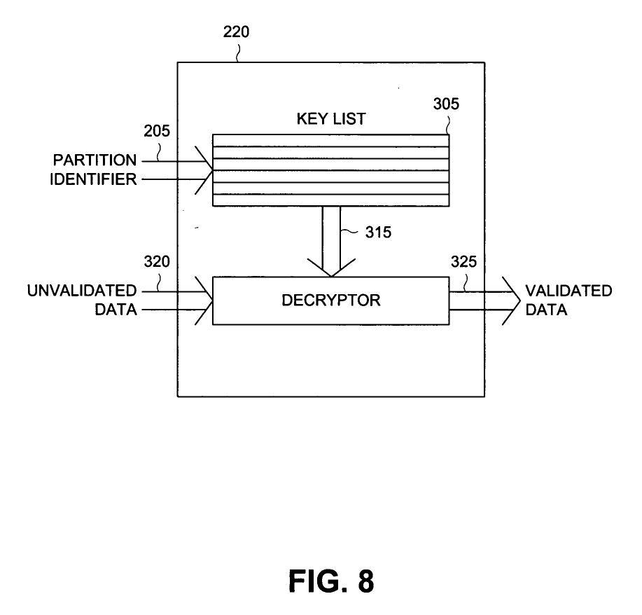

FIG. 8 is a block diagram depicts one alternative example embodiment of a validation unit capable of validating encrypted data. According to this example alternative embodiment, a validation unit 220 comprises an encryption key list 305. The encryption key list 305 uses a partition identifier 205 provided by the partition selector 200 to select one encryption key from a list of a plurality of encryption keys stored in the encryption key list 305. The validation unit 220 of this alternative embodiment further comprises a decryptor 310. The decryptor 310 receives unvalidated data 320 from the peripheral interface 225. Validated data 325 is generated by the decryptor 310 according to a selected encryption key 315. The decryptor provides validated data 325 to the processor interface 215. This example embodiment of a validation unit can be used where data has been previously stored in a memory in an encrypted manner.

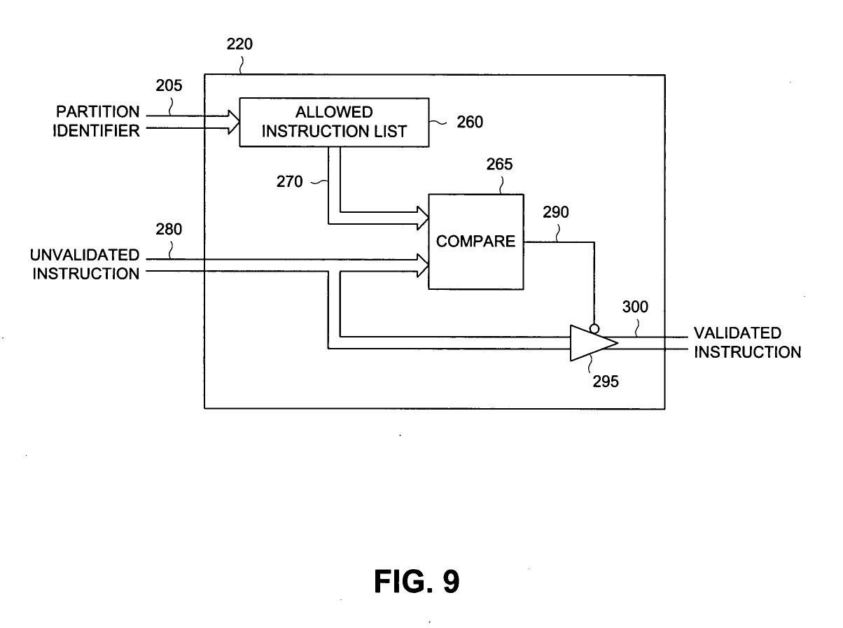

FIG. 9 is a block diagram that depicts yet another alternative embodiment of a validation unit that is capable of validating an instruction. According to this alternative embodiment, a validation unit 220 comprises an allowed instruction list 260 and a comparator 265. According to this alternative example embodiment, the allowed instruction list 260 receives a partition identifier 205 from the partition selector 200. The partition identifier 205 is used as a basis to select a subset of the allowed instruction list according to a partition. The partition identifier 205 reflects a currently active partition. Although not depicted in the figure, the validation unit 220 further comprises a controller. The controller of this alternative embodiment causes the validation unit 220 to receive an unvalidated instruction 280 from the peripheral interface 225. The unvalidated instruction 280 is compared against one or more instruction stored in a selected subset of the allowed instruction list 260. Accordingly, the controller will sequence through a subset of the allowed instruction list 260 in a manner so as to determine allowable instructions in a particular active partition according to the partition identifier 205.

Instructions stored in the allowed instruction list 260 are retrieved in a sequential manner and compared 265 to the unvalidated instruction 280. When the unvalidated instruction 280 is substantially equal to an instruction stored in the allowed instruction list 260 (i.e. a specific subset of the allowed instruction list 260 as selected according to the partition identifier 205), the comparator 265 generates a gate signal 290. The gate signal 290 controls the gate 295 which, when activated by the gate single 290, allows an unvalidated instruction 280 to propagate as a validated instruction 300 to the processor interface 215. Accordingly, the validated instruction is then provided to the processor interface 215. The processor then is allowed to execute the validated instruction in an ordinary manner. It should be appreciated that, according to yet another alternative embodiment, the allowed instruction list is replaced by a disallowed instruction list and the comparison logic that generates a gate signal 390 is adjusted accordingly.

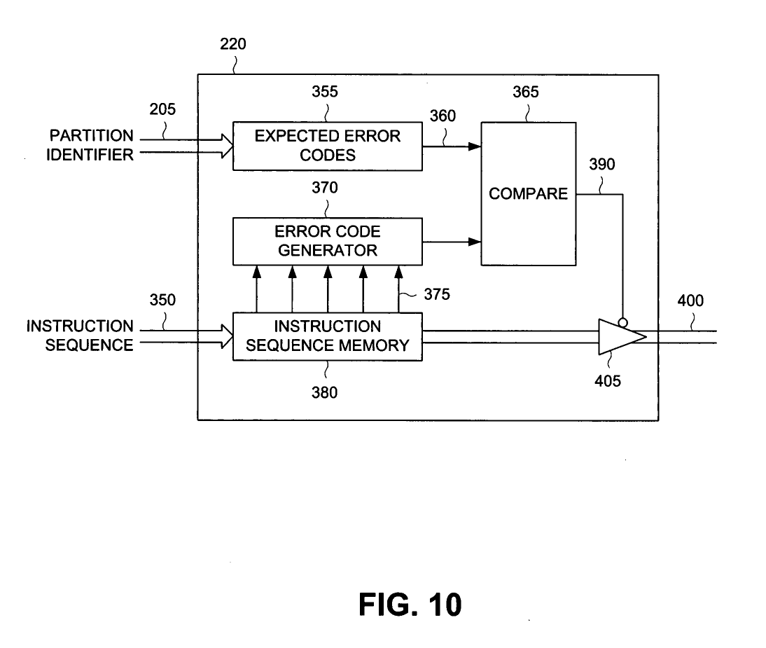

FIG. 10 is a block diagram that depicts another alternative embodiment of a validation unit capable of validating an instruction sequence. According to one alternative embodiment, the processor interface 215 is capable of receiving a request for an instruction sequence. The peripheral interface is further capable of retrieving an instruction sequence according to the instruction sequence request received by way of the processor interface 215. The validation unit of this alternative embodiment directs instruction sequence the processor interface 215 and its instruction sequence is validated. According to another alternative example embodiment, a validation unit 220 comprises an instruction sequence memory 380, an error code generator 370, a list of expected error codes 355, a comparator 365 and a gate 405. According to this alternative example embodiment, when the processor interface 215 receives an instruction sequence request from a processor, the processor interface 215 propagates the request for an instruction sequence to the validation unit 220. In response, the validation unit 220 uses the peripheral interface 225 to retrieve the requested instruction sequence 350 from a storage device (e.g. memory). The retrieved instruction sequence 355 is temporarily stored in the instruction sequence memory 380. Although not depicted in the figure, a controller causes the contents of the instruction sequence memory to be presented to the error code generator 370. The error code generator 370 generates an error code which is then presented to the comparator 365. The comparator 365 compares the error code it receives from the error code generator 370 to an error code it receives from the list of expected error codes. The list of expected error codes 355 provides one expected error code to the comparator by selecting an entry in the list according to a partition identifier 205 received from the partition selector 200. Accordingly, each particular partition has associated therewith an expected error code. When the error code generated by the error code generator 370 is substantially equivalent to the expected error code 360 received from the expected error code list 355, the comparator 365 generates a gate signal 390. In response to the gate signal 390, the controller directs the instruction sequence in stored in the instruction sequence memory 380 to the processor interface 215. The processor receives the validated instruction sequence from processor interface 215 and is allowed to execute the validated instruction sequence ordinarily.

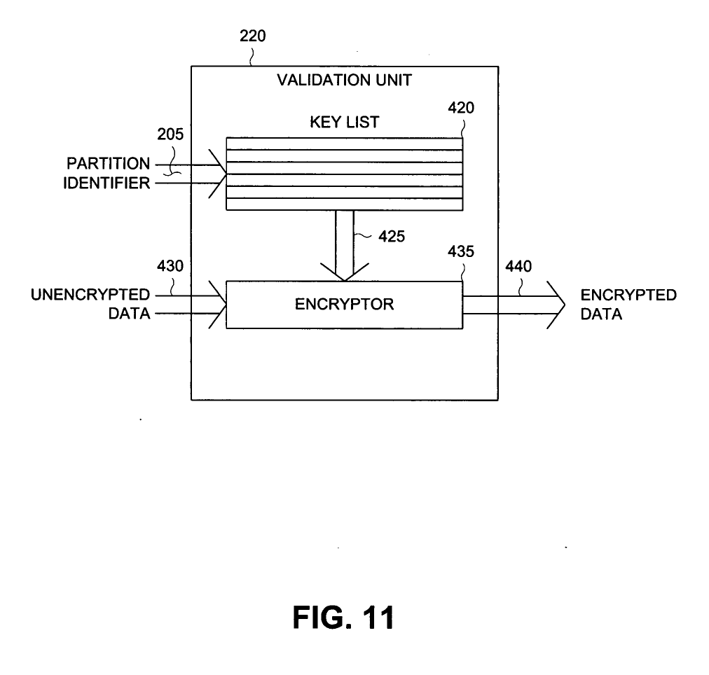

FIG. 11 is block diagram of one alternative example embodiment of a validation unit capable of encrypting data before it is stored in a memory. According to one alternative embodiment, an assurance processor 202 comprises a validation unit 220 that is capable of storing encrypted data in a peripheral device. For example, when a process is executed in a particular partition, a processor will perform a write operation in order to store data in memory. This action is typically referred to as a data storage cycle. Accordingly, this alternative embodiment of an assurance processor 202 comprises a processor interface 215 that is further capable of receiving a data storage cycle. The validation unit 220 of this alternative embodiment comprises an encryption key list 420 wherein are stored a plurality of encryption keys. A particular encryption key is selected from the encryption key list 420 by means of a partition identifier 205 received from the partition selector 200. The selected encryption key 425 is provided to an encryptor 435 which is also included in this alternative embodiment of a validation unit 220. The encryptor 435 receives encrypted data 430 from the processor interface 215. It should be noted that the processor interface 215 receives the unencrypted data from a processor attached to the processor interface 215. The encryptor encrypts the unencrypted data 430 according to the selected encryption key 425 and directs the encrypted data 440 to the peripheral interface 225. The peripheral interface 225 completes the write cycle by directing the encrypted data to a peripheral device (e.g. a memory).

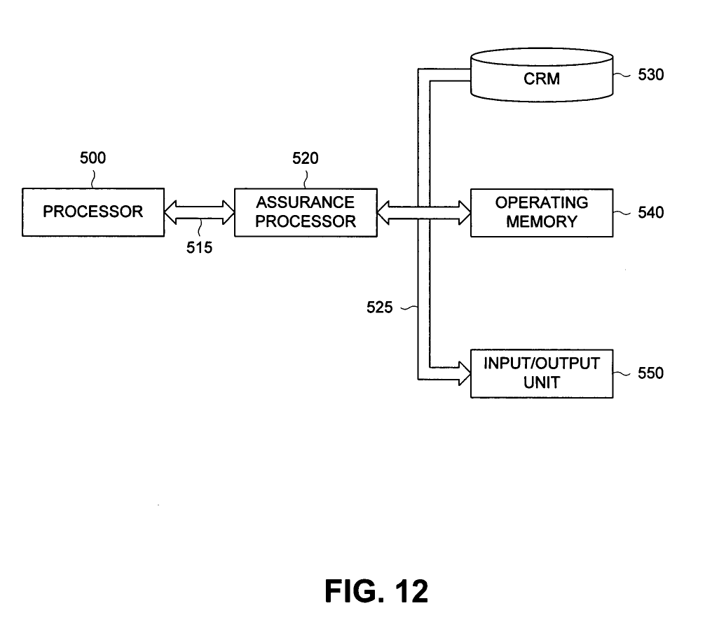

FIG. 12 is a block diagram that depicts one example embodiment of a high assurance processing system. According to this example embodiment, a high assurance processing system comprises a processor 500, an assurance processor 520 and an operating memory 540. It should be appreciated that the assurance processor 520 comprises an assurance processor commensurate with the teachings herein described and includes a partition selector, a processor interface 515, a peripheral interface 525 and a validation unit. Various other embodiments of a high assurance processing system include other alternative embodiments of an assurance processor as described heretofore. According to yet another example embodiment, a high assurance processing system further comprises a computer readable medium 530. The computer readable medium includes, but is not limited to a hard disk drive, a flash memory and other forms of data storage. According to yet another alternative embodiment, a high assurance processor further comprises an input unit 550. According to yet another alternative embodiment a high assurance processor 520 further comprises an output unit 550. It should be appreciated that any combination of a computer readable medium 530, an operating memory 540, and input/output unit 550 are interconnected with the assurance processor 520 by means of a peripheral interface 525 included in one example embodiment of an assurance processor 520. It should be appreciated that the processor 500 executed instructions stored in the operating memory 540. It should further be appreciated that the processor stores data in and retrieves data from the working memory 540. It should yet further be appreciated that the assurance processor performs validation functions for data as herein described. For example, various embodiments of the assurance processor will support data encryption and decryption as heretofore described. Yet another embodiment of the assurance processor will support instruction level validation. In yet another embodiment, the assurance processor will support instruction sequence validation.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

What is claimed is:

1. A method for high assurance processing using a commercial processor comprising:
selecting a first active partition;
receiving a processor access cycle from the commercial processor;
retrieving data from a device according to the processor access cycle;
validating the data according to a selected active partition; and
providing the data to the processor when the data validation is successful.

2. The method of claim 1 wherein validating the data comprises:
retrieving an encryption key for the first active partition; and
decrypting the retrieved data according to the encryption key.

3. The method of claim 1 wherein validating the data comprises:
identifying an instruction included in the data; and
determining when the instruction is allowed for the first active partition.

4. The method of claim 1 further comprising:
deselecting the first active partition;
receiving a request for an instruction sequence from the commercial processor;
retrieving an instruction sequence from a device according to the received request;
validating the retrieved instruction sequence according to the first active partition; and
providing the instruction sequence to the processor when the validation of the instruction sequence is successful.

5. The method of claim 4 wherein validating the retrieved instruction sequence comprises:
calculating an error code according to the instruction sequence;
comparing the calculated error code with an expected value; and
declaring the instruction sequence valid when the comparison is successful.

6. The method of claim 1 further comprising:
receiving a processor storage cycle;
retrieving an encryption key for the first active partition;
encrypt data included in the processing storage cycle according to the encryption key; and
direct the encrypted data to a device according to the processor storage cycle.

7. An assurance processor comprising:
partition selector capable of selecting a first active partition;
processor interface capable of receiving a processor access cycle;
peripheral interface capable of retrieving data from a peripheral device according to a processor access cycle received by the processor interface; and
validation unit capable of providing validating data according to data retrieved by the peripheral interface and according to a first active partition
wherein the processor interface if further capable of providing to a processor data the validated data provided by validation unit.

8. The assurance processor of claim 7 wherein the validation unit comprises:
encryption key list that provides an encryption key according to a partition identifier;
and
decryptor that provides decrypted data to the processor interface by decrypting data received from the peripheral interface according to an encryption key provided by the encryption list.

9. The assurance processor of claim 7 wherein the validation unit comprises:
allowed instruction list that selects an allowed instruction list according to a partition identifier;
comparator that generates an valid instruction signal when an instruction received from the peripheral interface is equal to an instruction included in a selected allowed instruction list; and
gate that allows an instruction received from the peripheral interface to be directed to the processor interface when the valid instruction signal is active.

10. The assurance processor of claim 7 wherein the validation unit comprises:
disallowed instruction list that selects a disallowed instruction list according to a partition identifier;
comparator that generates an valid instruction signal when an instruction received from the peripheral interface is not included in a selected disallowed instruction list; and
gate that allows an instruction received from the peripheral interface to be directed to the processor interface when the valid instruction signal is active.

11. The assurance processor of claim 7 wherein the processor interface is further capable of receiving a request for an instruction sequence from a processor and wherein the peripheral interface is capable of retrieving an instruction sequence according to the received request and wherein the validation unit validates the retrieved instruction sequence directs the instruction sequence to the processor interface when the instruction sequence is validated.

12. The assurance processor of claim 11 wherein the validation unit comprises an instruction sequence memory capable of storing an instruction sequence received by way of the peripheral interface and wherein the validation unit further comprises:
error code generator that generates an error code according to the contents of the instruction sequence memory;
expected error code list that provides an expected error code according to the partition identifier provided by the partition register;
comparator that generates an instruction sequence valid signal when the generates error code is substantially equivalent to the error code provided by the expected error code list; and
gate that directs the contents of the instructions sequence memory to the processor interface when the instruction sequence valid interface is active.

13. The assurance processor of claim 7 wherein the processor interface is further capable of receiving a data storage cycle and wherein the validation unit comprises:
encryption key list that provides an encryption key according to a partition identifier; and
encryptor capable of encrypting data received from the processor interface by way of a data storage cycle and providing the encrypted data to the peripheral interface wherein the peripheral interface directs the encrypted data to a peripheral.

14. A high assurance processing system comprising:
processor capable of executing an instruction sequence;
memory capable of storing at least one of data and an instruction sequence;
assurance processor comprising:
partition selector capable of selecting a first active partition;
processor interface capable of receiving a processor access cycle from the processor;
peripheral interface capable of retrieving data from a the memory according to a processor access cycle received by the processor interface; and
validation unit capable of providing validated data according to data retrieved by the peripheral interface and according to a first active partition
wherein the processor interface if further capable of providing to the processor validated data provided by validation unit.
according to the processor storage cycle.

15. The high assurance processing system of claim 14 wherein the validation unit comprises:
encryption key list that provides an encryption key according to a partition identifier; and
decryptor that provides decrypted data to the processor interface by decrypting data received from the peripheral interface according to an encryption key provided by the encryption list.

16. The high assurance processing system of claim 14 wherein the validation unit comprises:
allowed instruction list that selects an allowed instruction list according to a partition identifier;
comparator that generates an valid instruction signal when an instruction received from the peripheral interface is equal to an instruction included in a selected allowed instruction list; and
gate that allows an instruction received from the peripheral interface to be directed to the processor interface when the valid instruction signal is active.

17. The high assurance processing system of claim 14 wherein the processor interface is further capable of receiving a request for an instruction sequence from a processor and wherein the peripheral interface is capable of retrieving an instruction sequence according to the received request and wherein the validation unit validates the retrieved instruction sequence directs the instruction sequence to the processor interface when the instruction sequence is validated.

18. The high assurance processing system of claim 17 wherein the validation unit comprises an instruction sequence memory capable of storing an instruction sequence received by way of the peripheral interface and wherein the validation unit further comprises:
error code generator that generates an error code according to the contents of the instruction sequence memory;
expected error code list that provides an expected error code according to the partition identifier provided by the partition register;
comparator that generates an instruction sequence valid signal when the generates error code is substantially equivalent to the error code provided by the expected error code list; and
gate that directs the contents of the instructions sequence memory to the processor interface when the instruction sequence valid interface is active.

19. The high assurance processing system of claim 14 wherein the processor interface is further capable of receiving a data storage cycle and wherein the validation unit comprises:
encryption key list that provides an encryption key according to a partition identifier; and
encryptor capable of encrypting data received from the processor interface by way of a data storage cycle and providing the encrypted data to the peripheral interface wherein the peripheral interface directs the encrypted data to a peripheral.
